(19) United States
(12) Patent Application Publication
(10) Pub. No.: US 2011/0094122 A1
(43) Pub. Date: Apr. 28, 2011

(54) LAMINAR CONDITIONED EGG DRYING DEVICE

(75) Inventors: James Carlton Webb, Okemos, MI (US); Carl Gene Cooper, Garden City, MI (US); Wayne William Kelly, Canton, MI (US)

(73) Assignee: FPS FOOD PROCESSING SYSTEMS, B.V., Nootdorp (NL)

(21) Appl. No.: 12/906,365

(22) Filed: Oct. 18, 2010

Related U.S. Application Data
(60) Provisional application No. 61/253,937, filed on Oct. 22, 2009.

(51) Int. Cl. F26B 25/08; F26B 25/00

(52) U.S. Cl. 34/218; 34/236

(57) ABSTRACT

An egg dryer incorporating a rotating spool bar conveyor extending between an inlet end and an outlet end and upon which are supported a plurality of eggs conveyed through the body. An airflow exhibiting a humidity less than that associated with an environment outside the body is directed from the outlet end in a normal and opposing flowing direction relative to a direction of travel of the eggs. Subset flows of heated/desiccated air are also redirected to one or more intermediate header tubes arranged at internal locations of the body in communication with the conveyor and, in combination with impinging baffle plates mounted in proximity to the header tubes, provide additional and targeting drying of such as the ends of the eggs in combination with the overall heated/desiccated airflow.

### CROSS-REFERENCE TO RELATED APPLICATIONS

This application claims the benefit of U.S. Provisional Application 61/253,937 filed on Oct. 22, 2009.

### FIELD OF THE INVENTION

The present invention relates generally to an egg drying device, such as which is incorporated into an egg handling/transfer assembly. More particularly, the present invention discloses an improved egg drying device in which a lowered humidity (desiccated) air flow is introduced through a plenum in a generally parallel and opposing laminar condition relative to a path of travel of previously washed eggs conveying through an interior duct associated with the drier. The direction of the dried/heated airflow typically results in laminar flow across both upper and lower surfaces of the eggs, as well as of the continuously rotating spool bars upon which the eggs are supported. Additional subset flows of heated/desiccated air are also redirected from the supply plenum to one or more intermediate header tubes arranged at internal locations of the body and, in combination with impinging baffle plates mounted within the drying device in communication with the egg path of travel, provide targeting drying of such as the ends of the eggs upon which high speed ink printers subsequently apply coding data. In this fashion, continuous and concurrent drying of the spool bars assists in faster and more efficient drying of continuously introduced wet eggs.

### BACKGROUND OF THE INVENTION

The prior art is well documented with examples of egg drying devices, such as which can be incorporated into an egg transfer machine including such interconnected components as an inlet/orienter, washer, sorter, packager and, optionally, an egg breaker. Examples of existing egg drying apparatuses include such as those described in McCord, U.S. Pat. No. 4,173,831 and Heyer, U.S. Pat. No. 6,357,140.

U.S. Pat. No. 4,358,341, to Bergquist, further discloses a spray dryer incorporating an air flow system for moving air through a drying chamber at generally atmospheric pressure with a controlled laminar air flow. The product being dried is sprayed into the drying chamber by an air distributor plate with a rapid air flow through and immediately surrounding the product spray and with a surrounding air flow of lower velocity.

It has further been found that conventional egg drying devices employ room conditioned air (defined as standard interior air exhibiting ambient temperature and humidity) and which is directed in a perpendicular/downward fashion against the tops of the conveyed eggs and in the attempt to blow” water off the eggs and as opposed to drying the eggs. Such perpendicular airflow often includes properties of ambient temperatures (e.g. such as in the 75° F. range) and related humidity (such as further in the 60%-100% range depending upon the geographical location of the facility in which the egg transfer assembly is located).

Issues with the drying of eggs according to such prior art technologies include unequal drying of the egg upper and lower surfaces, as well as the inability to sufficiently dry the spool bars which are continuously wetted by the introduction of previously washed eggs. It has been found that the inability to consistently dry the spool bar surfaces within the dryer will result in continual transfer of moisture to newly admitted eggs, and in counteracting fashion to the efforts of the normal/angled airflow. An associated disadvantage resulting from the relative inability of existing egg dryer (blower) assemblies to adequately dry the eggs coming out of the dryer is the inability to apply various inking patterns or identifying logos to the outer egg shells, such as which are desired in order to identify type and grade.

Also, and given that the final rinse temperature of the eggs traveling through the preceding washer stage is often in the 120° F. range, the internal pasteurization and other advantages provided by heating the eggs below its effective boiling range tend to be quickly lost as the film condition formed upon the eggs rapidly equalize to the wet bulb temperature. Additionally, and as is often attendant with high humidity environments, a dew point temperature near that of the wet bulb temperature further results in the removal of most, if not all, of the driving force for mass (drying) transfer.

It has also been determined that, in instances where an egg core temperature is also within this range, the egg can actually become further wettened. In view of these disadvantages, it is found that an airflow dew point must be significantly less than an egg temperature in any given facility application. It has further been found that off line plants with refrigeration components require special consideration as a result of this dynamic of physics.

### SUMMARY OF THE INVENTION

The present invention discloses an egg drying device, such as which is incorporated into an egg handling/transfer assembly, in which a lowered humidity (desiccated) air flow is introduced from a dehumidifier component through a supply plenum for introduction at a generally outlet location of the dryer. The introduced airflow is redirected in a generally parallel and opposing laminar condition, counter to the direction of conveyance of the previously washed eggs supported upon the spool bars within the dryer, and towards the inlet end of the dryer. The direction of the dried (and typically heated) airflow typically results in laminar flow across both upper and lower surfaces of the eggs, as well as of the continuously rotating spool bars upon which the eggs are supported, and in order to provide more complete drying of the eggs, as well as continuous drying of the spool bars.

Additional subset flows of heated/desiccated air are also redirected from a branching location of the supply plenum for delivery to one or more intermediate header tubes arranged at internal locations of the body. Impinging baffle plates are mounted within the drying device in communication with the internal spool bar conveyor and proximate to the mounted location of associated header tubes.

The header tubes each exhibit pluralities of air discharge nozzles which are impinged upon and redirected by the configuration of the baffle plates for providing targeting drying of such as the ends of the eggs, such as upon which high speed ink printers subsequently apply coding data. In combination with the targeted delivery through the intermediate header tubes, the overall laminar flow associated with the plenum supplied desiccated air (at the outlet) assists in continuous and concurrent drying of both the eggs and associated spool bars upon which the eggs are translated/rotated, thereby achieving faster and more efficient drying of wet eggs, in part by preventing the spool bars from transferring moisture back to the conveyed eggs.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a plan view of the egg dryer and illustrating the general path of travel of the eggs through its lengthwise interior, the dehumidification structure incorporated into the body of the dryer, as well as the incorporation of underside attachable trays or other unit enclosing and tunnel defining structure for promoting the communication of an inner laminar airflow from an outlet location and in opposing fashion relative to the eggs conveyed through the drier duct/tunnel;

FIG. 2 is a perspective view of a dryer device incorporating the dehumidifier enclosing plenum structure for generating and delivering the laminar conditioned and desiccating airflow;

FIG. 3 is an enlarged and partially cutaway perspective of the dryer and further illustrating the concurrent features of the overall airflow introduced through the outlet in combination with the intermediate branching location of the desiccant supplied plenum which communicates, in succession, to a regenerative blower and heater, following which the targeted and heated desiccant airflow is delivered to an intermediate located header tube mounted in communication with the internal egg flow path;

FIG. 4 is a further rotated and lineal cutaway perspective depicting the spool supported conveyor path within the dryer and further illustrating a selected header tube in position relative to an associated baffle plate for providing targeted delivery of heated/desiccated air to specified eggs, this again in combination with the outlet originating and opposing/laminar heated airflow generated through the supply plenum as shown in FIG. 3;

FIG. 5 is an enlarged partial view taken from FIG. 4 of a selected sub-plurality of spool bars and eggs and further illustrating the manner in which the airflow is distributed around and underneath the eggs and supporting spool bars in order to promote drying of both; and

FIG. 6 is an enlarged partial view of an interface location established between a selected airflow redirecting baffle and a spool supported rotating/translating egg passing underneath the baffle and by which the pattern of airflow assists in expedited drying of the egg ends for subsequent inking, as well as assisting in thinning out the profile of the water film across the egg surface for encouraging more even egg drying by the overall laminar flow.

### DETAILED DESCRIPTION OF THE PREFERRED EMBODIMENTS

As previously described, the present invention teaches an improved egg drying device for more quickly and efficiently drying pre-washed eggs and in which a lowered humidity (desiccated) and typically heated air flow is introduced in a generally parallel and opposing laminar condition relative to a path of travel of the eggs conveying through an interior duct or defined tunnel associated with the drier. The egg drying device is typically incorporated into an egg transfer/handling assembly, such as between an egg washer and subsequent positioned grader and packer components, with it further being understood that the dryer can, without limitation, be employed in any manner or configuration of egg transfer or process assembly for drying washed eggs.

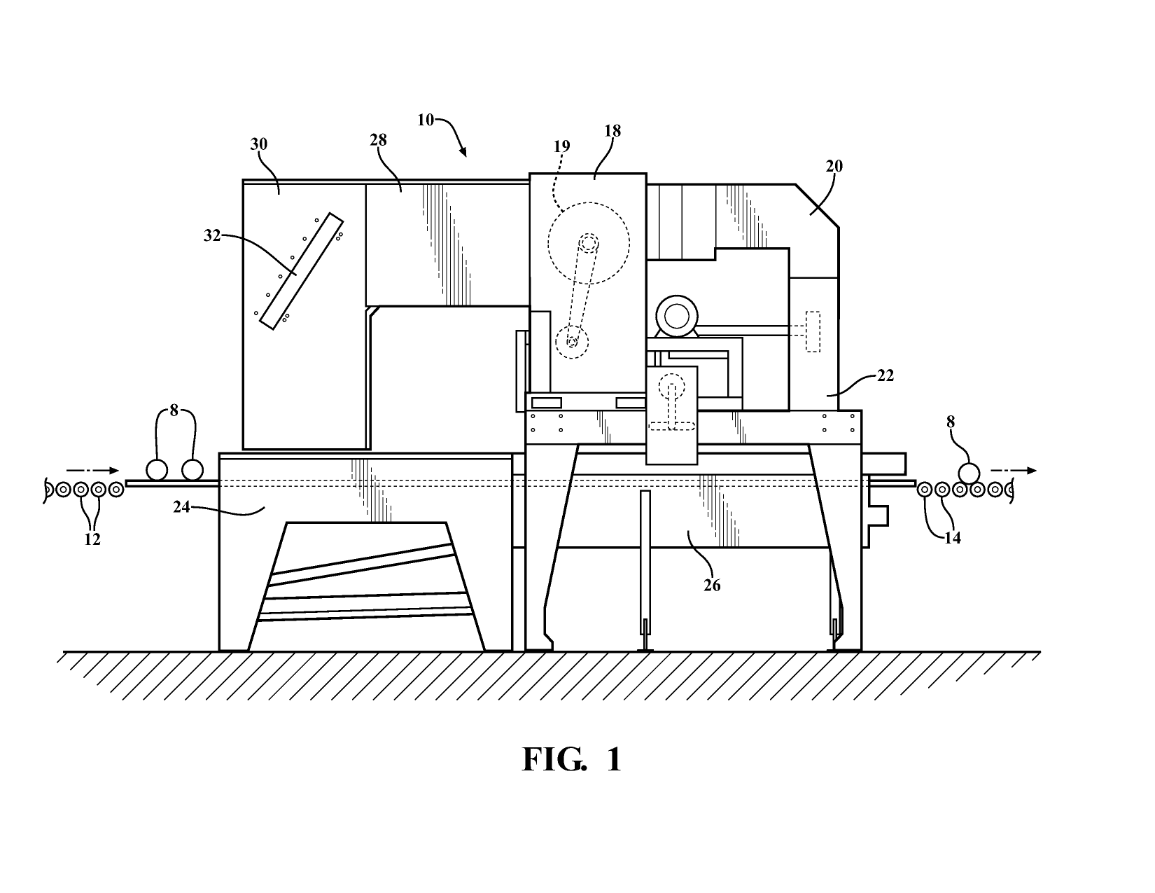

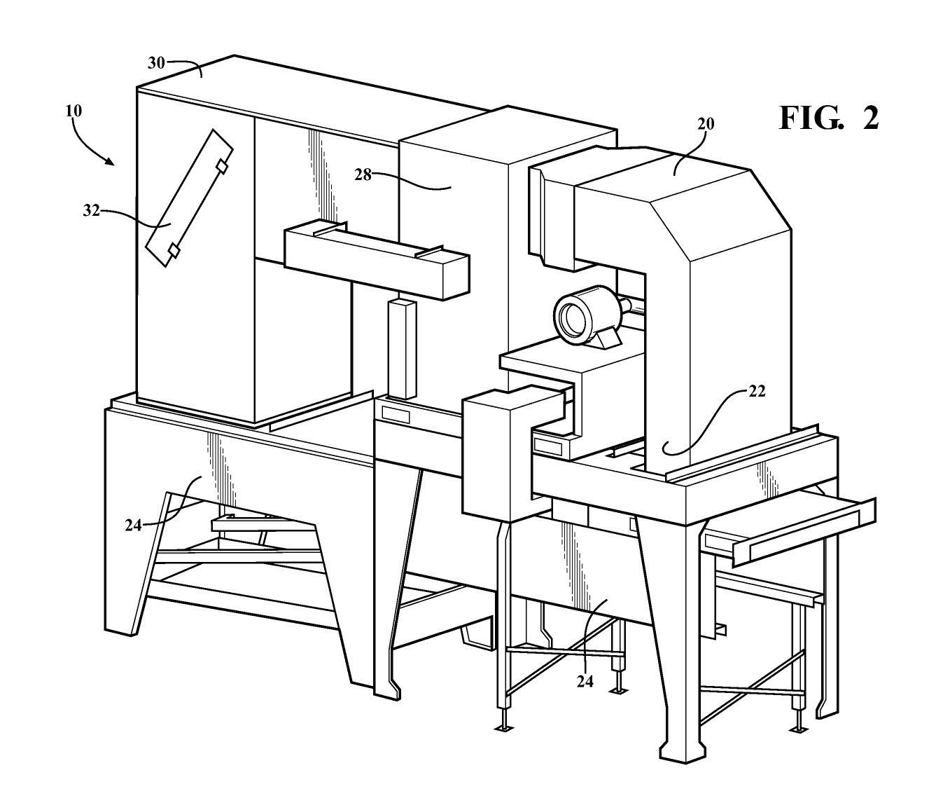

Referring now to FIGS. 1 and 2 in succession both plan and three dimensional perspective views are generally shown at 10 of a dryer device incorporating a laminar conditioned and desiccating airflow according to the present invention. The dryer 10 exhibits dimensions which can be generally standardized to existing egg transfer assemblies and, in a typical arrangement, defines an overall three dimensional shape with an inlet end for receiving eggs from a first section of spool conveyor and an opposite outlet end for communicating eggs from the dryer to a succeeding spool conveyor section with interconnects the same with a downstream process.

In one non-limiting application, the egg dryer can exhibit a length in the range of 65″ and which, given a routine spool conveyor speed associated with the transported eggs, results in an interior egg transit time of approximately 12-15 seconds between inlet and outlet ends. Although not shown, preceding the dryer is an egg washer station which is commonly employed for cleaning the eggs, such as which are communicated directly from hen laying houses, and for providing a continuous flow of wet eggs to the dryer 10.

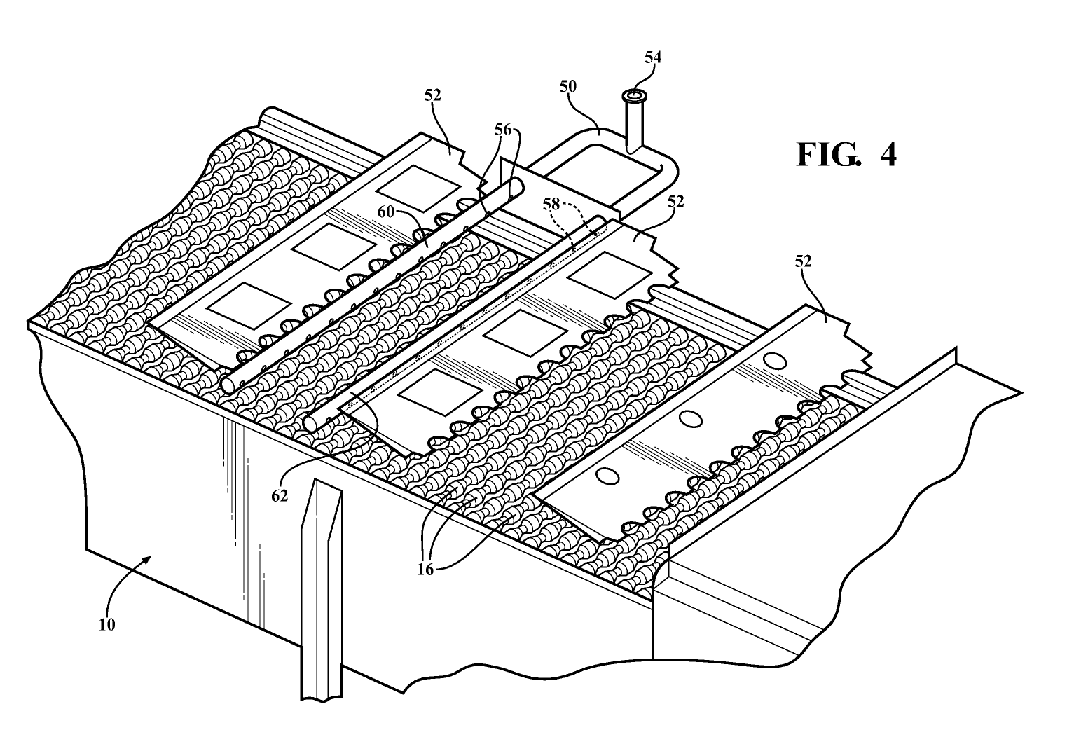

Following the dryer is any type of equipment not limited to an egg printer, grader and/or packer stations and which are interconnected by individual pluralities of the afore mentioned sections of rotatable driven spool conveyors (see as shown in FIG. 1 by inlet plurality of spools 12 preceding the dryer 10, as well as an outlet plurality of spool 14 established between the dryer 10 and the further piece of equipment such as a printer, grader, and/or packer. As further best depicted in the cutaway of FIG. 4, the interconnecting and internal conveyor path established within the dryer 10 is provided by a plurality of rotationally driven spool bars 16, these interconnecting the inlet 12 and outlet 14 spool conveyor sections for consecutively in-feeding wet/washed eggs and subsequently out-feeding dried eggs.

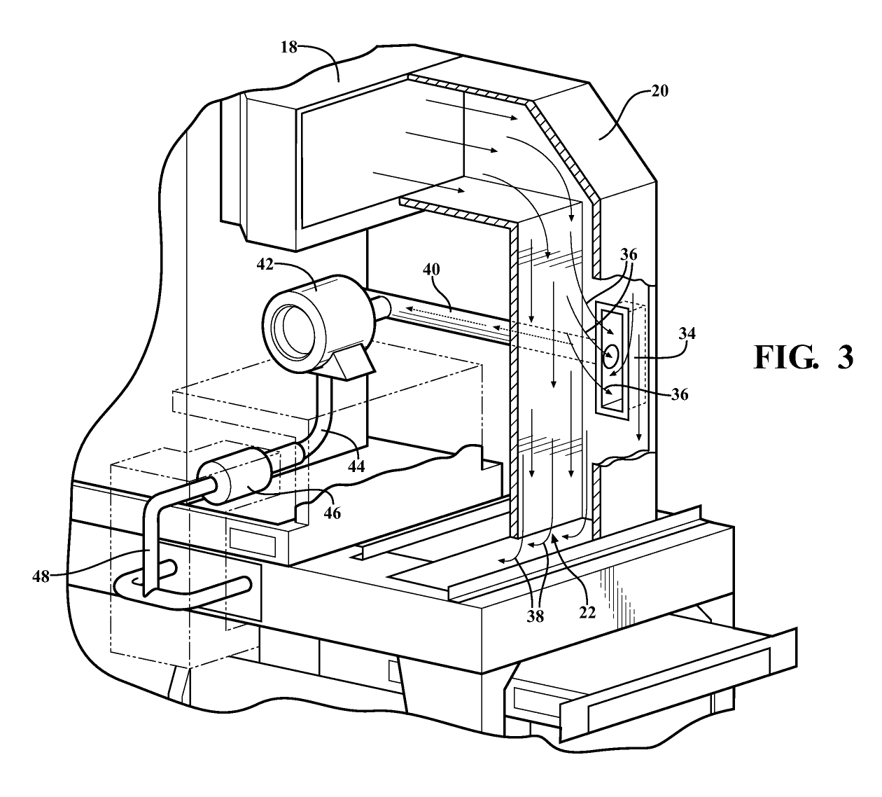

As best shown in the plan view of FIG. 1, the egg dryer 10 illustrates the general path of travel of the eggs through its lengthwise interior. A dehumidification structure is incorporated into the body of the dryer, see plenum section 18 incorporating a suitable heating/dehumidifying component (see further depicted in phantom at 19). An interconnecting section 20 of the plenum both draws and redirects a continual heated/desiccated airflow in a redirected fashion to an outlet proximate location 22 (see also FIG. 3) for flowing in a generally laminar pattern in a direction towards the inlet end of the dryer. Other features include the incorporation of underside attachable trays 24 and 26 which can be associated with individual and interconnecting sections of the dryer and which, as will be further described, promotes the creation of a fluid communicating tunnel or like structure for promoting generation of an inner laminar airflow in opposing fashion relative to the direction of conveyance of eggs 8 through the drier.

The dehumidification component 19 depicted is incorporated into the body of the dryer 10, at any suitable location within the interconnecting plenum structure and such as which can incorporate either or both of dryers and/or burners for assisting in reducing the humidity of the intake air. A blower structure or the like is also incorporated into the plenum and communicates the heated and reduced humidity air via the plenum ductwork 18 and 20 to the location identified and 22 approximate the dryer outlet.

A corresponding desiccant structure is concurrently employed to achieve a desired reduction in the humidity, such as by adding heat to the air stream after employment of a drying process. Other features include any type of pre-filtering of intake air and, as further shown in FIGS. 1 and 2 without limitation, encompass additional interconnected plenum sections 28 and 30 extending from an opposite inlet side of the plenum section 18 towards an inlet end of the dryer 10. A filter installation, see access door 32, is built into one of the plenum sections, such as that shown at 30, in order to pre-filter the air withdrawn into the plenum and prior to being heated/dried and out-fed to the dryer 10 at redirected outlet 22.

Alternative to a standard burner/dehumidification application, it is also envisioned that a direct expansion (DX) stage of a refrigeration cycle can be employed, this in effect occurring between the evaporation and condensation stages in which the heated/dried by-product of the cycle can be employed as the treated air medium. It is contemplated that removal of water by DX dehumidification can employ an evaporation temperature in a range of 32° F. to 40° F.t, this resulting in eventual dried air outputted in a desired range of 120° F. The use of condensation heat to warm and dry the air to a useful level corresponds to an amount equivalent to the latent heat removed from the return air, such as resulting in a desired airstream on the order of 110° F. with 10% humidity or less.

The desired interior conditions associated with the lengthwise interior passageway associated with the dryer are again promoted through the incorporation of the trays 24 and 26 (or other suitable enclosure), and which are typically three sided in order to substantially seal the interior extending length of the egg passageway within the dryer between its inlet and outlet ends. While not providing an absolutely airtight environment (given the open inlet and outlet ends of the dryer) the purpose of the trays or other suitable enclosing structure can be designed so as to be either fixedly or removably secured to the undersides of the dryer and in order to create a substantially controlled interior environment for the introduction of an opposing heated laminar airflow relative to the direction of the egg transfer.

FIG. 3 is an enlarged and partially cutaway perspective of the dryer 10 and further illustrating, in combination with the features of the overall airflow introduced through the outlet 22, the provision of an intermediate branching conduit location of the desiccant supplied plenum, see intermediate outlet location 34 which receives a subset volume of plenum supplied air (diverted arrows 36 from overall plenum outlet feed current depicted by subsequent arrows 38). A conduit section 40 extends from the intermediate plenum outlet 34 and communicates the subset air flow in succession to a regenerative blower 42 and, following a further interconnecting conduit section 44, is passed through a heater 46.

Following the heater 46, the now regenerated and reheated/desiccated subset airflow is fed, via an outlet tube 48 to one or more intermediate header tubes 50 mounted in widthwise extending and passageway communicating fashion within the egg flow conveying interior of the dryer. FIG. 4 is a further rotated and cutaway perspective illustration of a selected header tube 50 in position relative to an associated baffle plate 52 for providing targeted delivery of heated/desiccated air to locations of specified eggs 8, this in combination with the outlet 22 originating and opposing/laminar heated airflow (again directional arrows 38 in FIG. 3) generated through the supply plenum as shown in FIG. 3.

The invention contemplates in one non-limiting variant redesigning the outlet 48 to feed up to three individual header tubes 50 installed in spaced locations approximating the inlet, intermediate and outlet locations of the dryer. The non-limiting design of the selected header tube 50 depicted in the cutaway of FIG. 4 further illustrates a generally elongated “U” shape with an inlet 54 (for communicating with the heater 46 to an outlet location of the conduit 48). A plurality of spaced nozzles or discharge apertures are shown at 56 and 58 and are defined in spaced fashion along each of extending legs 60 and 62 of the selected header tube 50.

When viewed in combination with the overall cutaway perspective of FIG. 4, the enlarged partial view of FIG. 6 illustrates the construction of the planar and edge-serrated baffle plates 52, these being mounted in a generally slightly downward/declining fashion as depicted in FIG. 4. A forward edge of each of the baffle plates further exhibits such as a plurality of spaced apart and projecting toothed locations 60, these alternating with arcuate interconnecting edge profiles 62 and 64.

The design of the header baffle plates is such that each promotes targeted airflow delivered from the header tube nozzles 56 and 58 and redirected in a slightly downward fashion along the undersides of the baffle plates 52 (see again FIG. 4), following which the dried/heated current flow is distributed in the manner depicted by directional arrows 66 and 68 and which results from the modified forward edge configuration of the baffle plate. In this manner, the heated currents are directed around and underneath the eggs 8 and supporting spool bars 16 in order to promote drying of both.

As further best shown in FIG. 6, the spool bars 16 are aligned relative to the header tube nozzles 56 and 58 and associated alternating edge profiles 60, 62 and 64 of the baffle plates 52 in such as way that the positioning of the eggs in a collectively rotating/translating fashion allow for targeted drying zones created along opposite ends for facilitating subsequent inking at these locations. It is also found that, by virtue of the air currents 66 and 68 impinging upon the opposite egg ends, an overall thinning out the profile of the water film upon the is achieved (see additional arrows 70 for redirecting a portion of the wetted exterior towards the middle part of the egg and for encouraging more even egg drying).

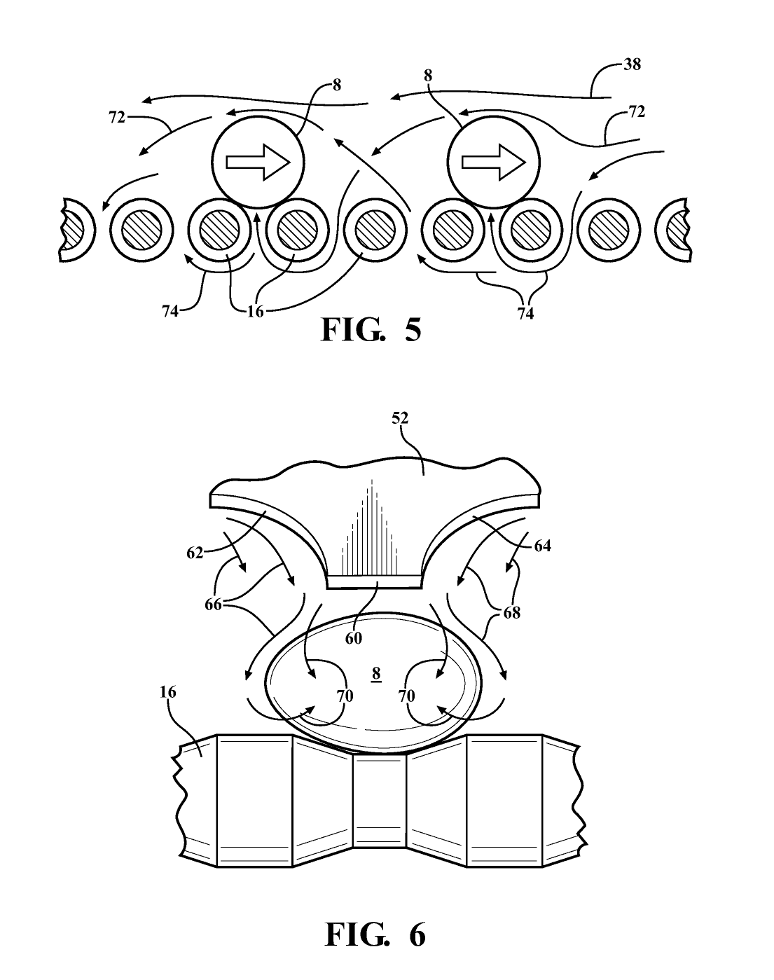

Concurrent with the targeted location drying achieved through the employment of the regenerative assembly and intermediate header tubes 50, FIG. 5 depicts an enlarged partial view taken from FIG. 4 of a selected sub-plurality of spool bars 16 and eggs 8 and further illustrating the manner in which the outlet 22 delivered airflow (arrows 38), upon establishing its opposing and inlet directed path of travel through the egg conveying zone, is caused to be distributed both around and underneath the eggs 8 and supporting spool bars 16 (see additional directional arrows 72 and 74) and in this fashion establishes more even and complete drying. The ability to pass drying and/or heated air currents both above and below the surfaces of the eggs and associated spool bars (and opposed to only drying the tops of the eggs) greatly increases the efficiency of drying of the eggs. Further, the ability to continuously dry the spool bars helps combat the incidence of previously deposited water droplets from being transferred back to surface of the conveyed eggs.

As described, one non-limiting performance variant of the assembly contemplates the outlet delivered airflow (performing according to the operational parameters described in reference to FIG. 5) occurring simultaneous with the targeted baffle plate induced patterns (FIG. 6), this in order to more quickly and efficiently promote both the overall drying profile of the eggs, as well as separately targeting and expediting drying of the egg ends such as to facilitate quicker and more effective inking of the eggs with any type of desired coding data. It is also envisioned and understood that other related variants of the present invention contemplate alternative employment of the overall plenum structure and/or the individual and regenerative air supplied header tubes and associated baffle plates mounted within specified locations (again FIG. 4).

It is further understood that the interior ductwork associated with the dryer 10 may be designed in order to allow the heated/desiccated airflow to be calibrated to any desired parameters, this in one non-limiting variant including such as airflow of 10-15 mph (equivalent to approximately 9″ per second). The ability of the airflow to pass across the eggs entire surface (as shown by the depicted airflow in FIG. 5) increases drying of both the eggs and the associated spool bars. It is also envisioned and understood that the concurrent targeted drying of the eggs (FIG. 6) can be modified through any suitable redesign of the intermediate header tubes 50 and/or the edge articulating baffle plates 52.

It is further found that the vacancies upon the spool bar conveyor when, in use with such as a cross current airflow as previously disclosed in reference to the prior art, tends to cause low pressure distortions which tend which reduces the effectiveness of the cross flow units. With the counter flow application of the present invention, such vacancies upon the spool bars are not exploited to create localized pressure disparities. In this fashion, continuous and concurrent drying of the spool bars assists in faster and more efficient drying of newly introduced wet eggs.

Having described my invention, other and additional preferred embodiments will become apparent to those skilled in the art to which it pertains, and without deviating from the scope of the appended claims.

I claim:

1. An egg dryer, comprising:
a body incorporating a conveyor extending between an inlet end and an outlet end and upon which is supported a plurality of eggs conveyed through the body; and
an airflow exhibiting a humidity less than that associated with an environment outside said body, said airflow being directed from an outlet of said body in a direction toward an inlet and opposing a direction of travel of the eggs.

2. The invention as described in claim 1, further comprising said airflow being heated to a temperature greater than the outside environment.

3. The invention as described in claim 1, further comprising a plurality of trays assembled underneath the body.

4. The invention as described in claim 1, further comprising at least one of a dehumidifier or direct expansion unit incorporated into said body and communicated with said outlet via a plenum structure associated with said body.

5. The invention as described in claim 3, further comprising said direct expansion unit utilizing an evaporation temperature of 32 to 40 degrees Fahrenheit.

6. The invention as described in claim 1, further comprising a dryer and a subsequent desiccant system incorporated into said body.

7. The invention as described in claim 1, said conveyor further comprising a plurality of aligned spool bars establishing a passageway through said body, said opposing airflow being directed both above and below said spool bars.

8. The invention as described in claim 4, further comprising an intermediate outlet location associated with said plenum which receives a subset volume of plenum supplied air, a conduit section extending from said intermediate outlet and communicating the subset air flow in succession to a regenerative blower and heater prior to delivery to targeted locations within said body in communication with said conveyor.

9. The invention as described in claim 8, further comprising at least one intermediate header tube in communication with said blower and heater and which is mounted in widthwise extending and passageway communicating fashion within the egg flow conveying interior of the dryer.

10. The invention as described in claim 9, said header tube further comprising a generally elongated “U” shape with an inlet, a plurality of spaced nozzles being provided in along each of respective extending legs.

11. The invention as described in claim 10, further comprising a baffle plate arranged in communication with said header tube for providing targeted delivery of heated/desiccated air to locations of specified eggs separately from and in combination with the airflow generated through said plenum structure and redirected from said outlet toward said inlet.

12. The invention as described in claim 11, further comprising said baffle plate being mounted in an inclined fashion relative to said header tube nozzles such that projecting forward edge toothed locations of said baffle plate alternate with arcuate interconnecting locations for causing the targeted airflow from said header tubes to be redirected from said baffle plates around the edges of each egg.

13. An egg dryer, comprising:
a body incorporating a plurality of parallel arranged and rotating spool bars defining a conveyor extending between an inlet end and an outlet end of said body, a plurality of eggs supported upon said conveyor for passage through said body; and
a conditioned airflow exhibiting at least one of a humidity less than that associated with an environment outside said body and a temperature in excess of the outside environment, said airflow being directed toward said inlet end and opposing a direction of travel of the eggs.

14. The invention as described in claim 13, said body further comprising a plenum structure incorporating a dehumidifier component and a blower, said plenum structure redirecting said conditioned airflow from a location approximate said outlet end.

15. The invention as described in claim 13, said body further comprising a plenum structure for feeding a volume of air to a conduit section for delivery to one or more internal locations of said body.

16. The invention as described in claim 15, said conduit section extending from an intermediate outlet defined in said plenum structure and communicating a subset air flow in succession to a regenerative blower and heater prior to delivery to said body.

17. The invention as described in claim 16, further comprising at least one header tube in communication with said blower and heater and which is mounted in widthwise extending and passageway communicating fashion within the egg conveying interior of the dryer.

18. The invention as described in claim 17, said header tube further comprising a generally elongated “U” shape with an inlet, a plurality of spaced nozzles being provided in along each of respective extending legs.

19. The invention as described in claim 18, further comprising a baffle plate arranged in communication with said header tube for providing targeted delivery of heated/desiccated air to locations of specified eggs.

20. The invention as described in claim 19, further comprising said baffle plate being mounted in an inclined fashion relative to said header tube nozzles such a location established by projecting forward edge toothed locations of said baffle plate alternating with arcuate interconnecting locations causes targeted airflow from said header tubes to be redirected from said baffle plates around opposite edges of each egg.
